(19) United States
(12) Patent Application Publication
(10) Pub. No.: US 2025/0229741 A1
(43) Pub. Date: Jul. 17, 2025

(54) COVER ELEMENT, AIRBAG MODULE, DASHBOARD, VEHICLE SAFETY SYSTEM AND METHOD

(71) Applicants: Dalphi Metal España SLU, Vigo (ES); ZF AUTOMOTIVE GERMANY GMBH, Alfdorf (DE)

(72) Inventors: Diego PINTOS, Arroyo de la Encomienda (ES); Julio GALLEGO, Vigo (ES)

(21) Appl. No.: 18/854,350

(22) PCT Filed: Apr. 5, 2023
(86) PCT No.: PCT/EP2023/058929

§ 371 Date: Oct. 4, 2024

(30) Foreign Application Priority Data
Apr. 7, 2022 (DE) 10 2022 108 405.1

(51) Int. Cl. B60R 21/2165; B60R 21/205; B60R 21/215

(52) U.S. Cl. CPC B60R 21/2165; B60R 21/205; B60R 2021/21537

(57) ABSTRACT

The invention relates to a cover element for an airbag module comprising a tear line and at least one hinge area for opening the cover element by swiveling at least one flap which is formed by the tear line when the cover element is opened, wherein at least one stiffening rib having a weakened material portion extends between the tear line and the hinge area. The cover element excels by the fact that the weakened material portion is configured on the side of the hinge area.

### TECHNICAL FIELD

The invention relates to a cover element for an airbag module comprising the features of the preamble of claim 1. A cover element of this type is known, for example, from DE 197 01 106 A1. The invention also relates to an airbag module, an instrument panel and a vehicle safety system, each comprising a cover element of this type, as well as to a method for opening a cover element.

### BACKGROUND

The cover element serves to cover an airbag in the idle state toward the vehicle interior and to retain the airbag inside the airbag module. To this end, the cover element must be sufficiently stiff to withstand the packing pressure of the compressed airbag without bulging or deforming. When the airbag module is triggered, the cover element must be easy to open so as to release the airbag which deploys in the vehicle interior. In so doing, no fragments may detach from the cover element and get into the vehicle interior. Opening is performed along a tear line which is configured in the cover element.

The dimensional stability of the cover element is achieved by stiffening ribs. For opening the cover element, the stiffening ribs according to DE 197 01 106 A1 are provided, in the area of the tear line, with a weakened material portion resulting in the stiffening ribs breaking at the tear line during opening. The cover element is unfolded about a hinge area to release the airbag. The stiffening ribs are flattened in the hinge area. Hence, the hinge area is free from stiffening ribs, as they were assumed to impede or obstruct unfolding of the cover element.

The known cover element involves the risk that the cover element breaks in an uncontrolled manner and parts thereof are flung into the passenger compartment. Moreover, there is the risk that the cover element does not break open along the dedicated tear line, but that an uncontrolled tear line is formed (bypass) which obstructs inflation and deployment of the airbag.

### SUMMARY

The object underlying the invention is to state a cover element for an airbag module the opening behavior of which is improved and the dimensional stability is maintained as far as possible. The invention is based on the further object to state an airbag module, an instrument panel, a vehicle safety system and a method for opening a cover element.

In accordance with the invention, this object is achieved, in terms of the cover element for an airbag module, by the subject matter of claim 1. In terms of the airbag module, the instrument panel, the vehicle safety system and the method, the object is achieved by the subject matters of the claims 13, 14, 15 and 16.

Concretely, the object is achieved by a cover element for an airbag module that includes a tear line and at least one hinge area for opening the cover element by swiveling at least one flap. The flap is formed by the tear line when the cover element is opened. At least one stiffening rib having a weakened material portion extends between the tear line and the hinge area. In accordance with the invention, the weakened material portion is configured on the side of the hinge area.

The stiffening rib extends at least between the hinge area on one side thereof and the area of the tear line on the other side thereof. Preferably, it extends beyond each of said areas.

In contrast to the state of the art, the weakened material portion of the stiffening rib is configured on the side of the hinge area. This causes the cover element to unfold in a controlled manner around the hinge area when the airbag module is triggered. The weakened material portion of the stiffening rib on the side of the hinge area causes the hinge area to be released, when the stiffening rib breaks at the weakened material portion upon opening of the cover element. Accordingly, the bending moments acting upon the hinge area during opening are reduced so that the cover element is allowed to unfold in a controlled manner around the hinge area. Thereby the protection from uncontrolled breaking against detaching parts of the cover element is improved.

The flap or, resp., flaps of the cover element does/do not form before the airbag module is released, when the tear line is broken. The flap or, resp., flaps then swivel(s) open around the hinge area. In the idle state, the flaps are formed integrally with the cover element and cover the airbag.

If the cover element includes plural stiffening ribs, all stiffening ribs or at least several of the stiffening ribs may include a respective weakened material portion on the side of the hinge area.

Preferred embodiments of the invention are described in the subclaims.

Preferably, the weakened material portion is formed at an axial end of the stiffening rib. The axial end is disposed on the side of the hinge area. This enables a large effective length of the stiffening rib to enhance the stiffness.

In a particularly preferred embodiment, the hinge area comprises a hinge line about which the flap forming upon tearing along the tear line can be swiveled for opening the cover element.

In particular, the stiffening rib is provided to extend on both sides of the hinge line. Accordingly, the stiffening rib crosses and, resp., bridges the hinge line from one side of the hinge line to the other side of the hinge line, preferably at an angle of 90°.

The weakened material portion is disposed in the area of the hinge line, and specifically on the hinge line.

In contrast to the state of the art in which the hinge area forms a more or less undefined surface of the cover element, the hinge line offers the advantage that the cover element includes a defined swivel axis around which the flap swivels upon opening of the cover element. When the weakened material portion is disposed on the hinge line, the controlled unfolding of the cover element is further improved.

The stiffening rib may end at the tear line or at a distance in front of the tear line. This offers the advantage that for each stiffening rib one single weakened material portion is sufficient, namely on the side of the hinge area to achieve controlled opening of the cover element.

To enhance the stiffness, at least one stiffening rib may be disposed on each of the two sides of the tear line, the stiffening ribs including, on each of the two sides of the tear line, a weakened material portion configured on the respective side of the hinge area. This allows for a stiffening of the cover element over a quite large surface of the cover element. This embodiment is particularly suited for cover elements having so-called H flaps in which the tear line extends approximately centrally across the cover element so that, upon opening, flaps are formed on both sides of the cover element. This embodiment includes two hinge areas which are also disposed on both sides of the tear line.

As an alternative, it is possible that the stiffening rib extends beyond the tear line and has a further weakened material portion in the area of the tear line. Thus, the whole width of the cover element can be stiffened throughout by one single stiffening rib. This embodiment is also suited for a cover element including H flaps.

As stated in the foregoing, the tear line may be disposed between two flaps each having a hinge area for opening the cover element (H flaps). As an alternative, the cover element can be used in U flap design in connection with the invention. In this case, the tear line is configured at the edge of one single flap (U flap).

Preferably, the weakened material portion extends transversely to the longitudinal extension of the stiffening rib. Consequently, the stiffening rib tears open in the transverse direction.

If plural stiffening ribs are provided, each of the weakened material portions configured in the respective stiffening ribs extends along the hinge line. Thus, a uniform unfolding behavior along the hinge line is achieved.

Preferably, the weakened material portion comprises an area of the stiffening rib the wall thickness of which is smaller than the wall thickness of the remaining stiffening ribs. In this way, in the area of the weakened material portion a stress concentration is achieved which acts as predetermined breaking point.

The weakened material portion may be U-shaped or V-shaped.

Within the scope of the invention, an airbag module, an instrument panel and a vehicle safety system, each having a cover element according to the invention, are claimed.

In the method for opening a cover element according to the invention, at first the airbag module is triggered. Then the tear line tears open and a bending moment generating a stress concentration in the area of the weakened material portion acts upon the stiffening rib. The stiffening rib breaks at the weakened material portion. The cover element swivels around the hinge area and unfolds. Thus, the cover element is opened in a controlled manner.

### BRIEF DESCRIPTION OF THE DRAWINGS

In the following, the invention shall be illustrated in further detail based on an embodiment with reference to the attached schematic drawings, wherein:

FIG. 1 shows a perspective view of a cover element according to an embodiment of the invention, and

FIG. 2 shows a top view onto the cover element according to FIG. 1 in a schematic representation.

### DESCRIPTION

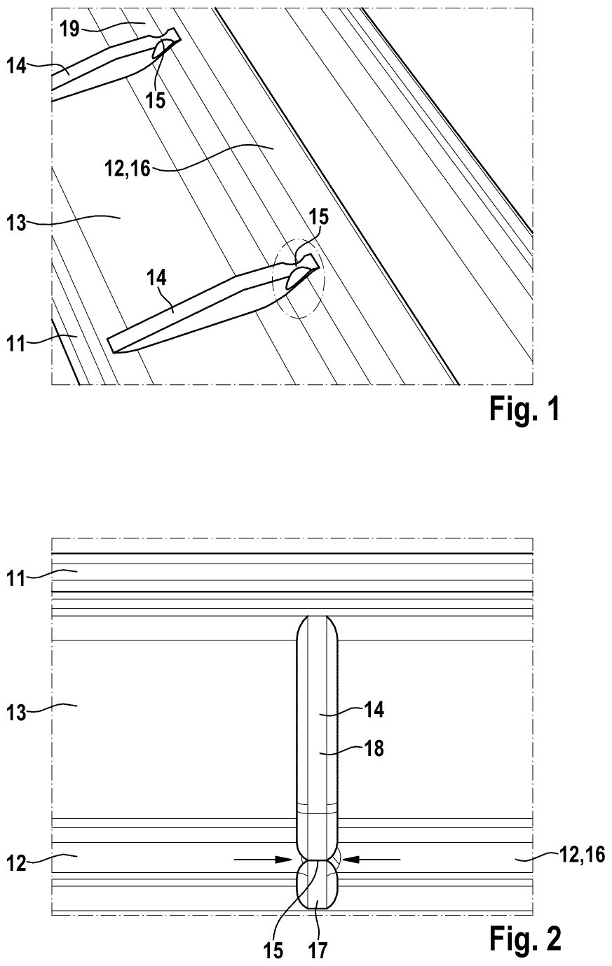

FIG. 1 illustrates a cover element according to an embodiment of the invention which is used to cover an airbag in an airbag module. The cover element may be used, for example, in a driver airbag or a passenger airbag. Other possible applications in a vehicle safety system are imaginable.

The cover element includes, on its inside, a tear line 11 which tears open when the cover element is opened and releases the airbag disposed beneath the cover element. The tear line 11 defines flaps 13 which swivel upward after tearing of the tear line 11 and release the airbag (H flaps). As an alternative, the tear line 11 may extend at the edge of the cover element so that one single flap is formed during opening (U flap). In a cover element of an H flap design, two hinge areas 12 are arranged facing each other about which the two flaps are swiveled when the cover element is opened. The hinge areas 12 and the tear line 11 extend approximately in parallel to each other. A different arrangement of the tear line 11 and the hinge areas 12 relative to each other is possible.

In the case of a U flap design, one single hinge area 12 extending in parallel to the tear line 11 is provided. In this case, too, different configurations are possible. The flap 13 is configured between the hinge area 12 and the tear line 11. This is also applicable to plural flaps 13 which are delimited on both sides of the tear line 11 by the respective hinge area 12.

It is understood that, in the idle state of the cover element, the flaps 13 are closed and are formed integrally with the cover element.

As is further evident from FIG. 1, plural stiffening ribs 14 extend between the tear line 11 and the hinge area 12. Concretely, the stiffening ribs 14 extend perpendicularly to the tear line 11 and to the hinge area 12. A different positioning of the stiffening ribs 14 is possible.

As is clear from FIGS. 1 and 2, the weakened material portion 15 of each of the stiffening ribs 14 is configured on the side of the hinge area 12. This means that the weakened material portion 15 is configured more closely to the hinge area 12 than to the tear area 11, namely so closely that the hinge effect is assisted by breaking the weakened material portion 15 upon opening. In the example, the weakened material portion 15 is directly adjacent to the hinge area 12.

Concretely, the hinge area 12 is configured as a hinge line 16 which forms, when the cover element is opened, an axis of rotation for the flaps 13 or, resp., the only flap 13. The weakened material portions 15 in the stiffening ribs 14 are aligned with the hinge line 16. In other words, all weakened material portions 15 are disposed on the hinge line 16.

As can be seen in FIG. 1, the height of the stiffening rib 14 is increased in the direction of the hinge area 12 and, resp., of the hinge line 16. The maximum height of the stiffening ribs 14 is configured adjacent to the hinge area 12 and, resp., the hinge line 16. The weakened material portion 15 is configured at the axial end of the stiffening rib 14 which extends into the hinge area 12, as is clear from FIG. 2. Accordingly, the weakened material portion 15 divides the stiffening ribs 14 into short and long sections 17, 18. The short section 17 projects at least partially outward from the hinge line 16. Concretely, the short section 17 is connected to a transverse rib 19 of the cover element that extends in parallel to the hinge line 16.

The weakened material portion 15 is configured directly on the hinge line 16.

After the weakened material portion 15 has broken, the short section 17 remains substantially stationary, i.e., it does not swivel along with the flap 13. The long section 18 is configured in the area of the flap 13 and swivels open with the latter when the cover element is opened.

Instead of the defined hinge line 16, also a flat hinge area as known from DE 197 01 106 A1, for example, can be combined with the stiffening rib 14 and the weakened material portion 15 to improve the opening behavior. Other hinge configurations are possible.

The tear line 11 is disposed spaced apart from the hinge line 16. The stiffening rib 14 extends between the hinge line 16 and the tear line 11. As can be seen in FIG. 1, the stiffening rib 14 runs out toward the tear line 11. In so doing, the height of the stiffening rib 14 flattens so that the stiffening rib 14 ends in front of the tear line 11. Thus, the tear line 11 can tear unhindered by the stiffening rib 14. A different geometry of the stiffening rib 14 is possible. For example, the stiffening rib 14 can protrude from the tear line 11. The opening is enabled by a further (second) weakened material portion in the area of the tear line.

The operating mode of the cover element is as follows.

In the event of an impact of the vehicle, the airbag module is triggered and a gas generator (not shown) fills the airbag with gas. Thus, the cover element is blown along the tear line 11 and the flaps 13 are outwardly bent up. This results in a stress concentration in the area of the weakened material portion 15 leading to the stiffening ribs 14 breaking open at the weakened material portion 15. The flaps 13 thus can swivel open unhindered around the hinge line 16 and, resp., generally around the hinge area 12. The airbag is released and can expand unhindered into the vehicle interior.

### LIST OF REFERENCE NUMERALS

10 void
11 tear line
12 hinge area
13 flap
14 stiffening rib
15 weakened material portion
16 hinge line
17 short section
18 long section
19 transverse rib

1. A cover element for an airbag module comprising a tear line and at least one hinge area for opening the cover element by swiveling at least one flap which is formed by the tear line when the cover element is opened, wherein at least one stiffening rib having a weakened material portion extends between the tear line and the hinge area,
wherein
the weakened material portion is configured on the side of the hinge area.

2. The cover element according to claim 1,
wherein
the weakened material portion is configured at an axial end of the stiffening rib which is disposed on the side of the hinge area, and/or in that the stiffening rib extends on both sides of the hinge area.

3. The cover element according to claim 1,
wherein
the hinge area comprises a hinge line about which the flap can be swiveled for opening, wherein the weakened material portion is disposed in the area of the hinge line, in particular on the hinge line.

4. The cover element according to claim 1,
wherein
the stiffening rib ends at the tear line or at a distance in front of the tear line.

5. The cover element according to claim 4,
wherein
at least one stiffening rib is disposed on each of both sides of the tear line having a weakened material portion which is configured on the respective side of the hinge area.

6. The cover element according to claim 1,
wherein
the stiffening rib extends beyond the tear line and has a further weakened material portion in the area of the tear line.

7. The cover element according to claim 1,
wherein
the tear line is disposed between two flaps each having a hinge area for opening the cover element.

8. The cover element according to claim 1,
wherein
the tear line is configured at the edge of one single flap.

9. The cover element according to claim 1,
wherein
the weakened material portion extends transversely to the longitudinal extension of the stiffening rib.

10. The cover element according to claim 3,
wherein
in plural stiffening ribs the respective weakened material portion extends along the hinge line.

11. The cover element according to claim 1,
wherein
the weakened material portion comprises an area of the stiffening rib the wall thickness of which is smaller than the wall thickness of the remaining stiffening ribs.

12. The cover element according to claim 1,
wherein
the weakened material portion is U-shaped or V-shaped.

13. An airbag module comprising a cover element according to claim 1.

14. An instrument panel comprising a cover element according to claim 1.

15. A vehicle safety system comprising a cover element according to claim 1.

16. A method for opening a cover element according to claim 1 comprising:
a) configuring the airbag module to be released,
b) configuring the tear line to tear so that a moment acts upon the stiffening rib, said moment being configured to generate a stress concentration in the area of the weakened material portion,
c) configuring the stiffening rib to break at the weakened material portion so that the cover element swivels about the hinge area and unfolds.
